(19) United States
(12) Patent Application Publication
(10) Pub. No.: US 2017/0211442 A1
(43) Pub. Date: Jul. 27, 2017

(54) EXHAUST EMISSION CONTROL APPARATUS FOR INTERNAL COMBUSTION ENGINE

(71) Applicant: TOYOTA JIDOSHA KABUSHIKI KAISHA, Toyota-shi (JP)

(72) Inventors: Kazuhiro UMEMOTO, Ebina-shi (JP); Toshihiro MORI, Gotenba-shi (JP)

(73) Assignee: TOYOTA JIDOSHA KABUSHIKI KAISHA, Toyota-shi (JP)

(21) Appl. No.: 15/405,597

(22) Filed: Jan. 13, 2017

(30) Foreign Application Priority Data
Jan. 22, 2016 (JP) 2016-010917

(51) Int. Cl. F01N 3/023; F01N 3/035; B01J 35/04; B01D 46/00; B01D 46/46; F01N 3/025; F02D 41/02

(52) U.S. Cl. CPC F01N 3/0232; F01N 3/025; F01N 3/035; F02D 41/025; F02D 41/029; B01D 46/006; B01D 46/46; B01D 46/0027; B01J 35/04; F02D 2200/0812; B01D 2279/30

(57) ABSTRACT

An exhaust emission control apparatus for an engine includes an ECU. The ECU is configured to: execute particulate matter removal control by controlling the engine such that a temperature of a particulate filter is increased to a predetermined PM removal temperature in order to reduce an amount of particulate matter collected in the particulate filter; and when the ECU determines that the amount of particulate matter collected in the particulate filter is smaller than or equal to a predetermined set collection amount, execute ash desorption control by controlling the engine such that the temperature of the particulate filter is increased to a predetermined ash desorption temperature and is kept at the ash desorption temperature or higher in order to reduce an amount of ash deposited in the particulate filter. The ash desorption temperature is a temperature suitable for converting the ash into calcium oxide.

### INCORPORATION BY REFERENCE

The disclosure of Japanese Patent Application No. 2016-010917 filed on Jan. 22, 2016 including the specification, drawings and abstract is incorporated herein by reference in its entirety.

### BACKGROUND

1. Technical Field

The present disclosure relates to an exhaust emission control apparatus fir an internal combustion engine.

2. Description of Related Art

There is known an exhaust emission control apparatus for an internal combustion engine, in which a particulate filter for collecting particulate matter contained in exhaust gas is arranged in an engine exhaust passage. As the amount of particulate matter accumulated in the particulate filter increases, a pressure loss in the particulate filter increases. As the pressure loss in the particulate filter increases, engine output power can decrease. For this reason, the exhaust emission control apparatus executes particulate matter (PM) removal control for increasing the temperature of the particulate filter and keeping the increased temperature at the time when the amount of particulate matter collected in the particulate filter is large, thus oxidizing and removing the particulate matter.

Incidentally, a non-combustible component called ash is also contained in exhaust gas, and the ash is collected in the particulate filter together with particulate matter. However, even when the particulate matter removal control is executed, ash does not burn or vaporize. That is, ash is not removed from the particulate filter, and remains in the particulate filter. Therefore, even when the particulate matter removal control is executed, the pressure loss in the particulate filter is not sufficiently recovered.

There is publicly known an exhaust emission control apparatus for an internal combustion engine, in which ash collected in a particulate filter is atomized and, as a result, the ash passes through the particulate filter to be removed from the particulate filter (see, for example, Published Japanese Translation of PCT Application No. 2014-520226 (JP-A-2014-520226)). In this exhaust emission control apparatus, solid acid is supported on the particulate filter, and the acid strength of the solid acid is higher than the acid strength of sulfurous acid and lower than the acid strength of sulfuric acid. In order to atomize ash, the concentration of oxygen in exhaust gas flowing into the particulate filter is temporarily decreased, and the temperature of the particulate filter is temporarily increased. When ash passes through the particulate filter to be removed from the particulate filter, an increased pressure loss in the particulate filter due to the ash is reduced.

### SUMMARY

However, solid acid is indispensable to the exhaust emission control apparatus described in JP-A-2014-520226, so the apparatus is complex and high-cost. The present disclosure provides an exhaust emission control apparatus that reduces an increased pressure loss in a particulate filter due to ash with a simple low-cost configuration.

An aspect of the present disclosure provides an exhaust emission control apparatus for an internal combustion engine. The exhaust emission control apparatus includes a particulate filter and an electronic control unit. The particulate filter is arranged in an exhaust passage of the internal combustion engine. The particulate filter is configured to collect particulate matter in exhaust gas. The electronic control unit is configured to (i) execute particulate matter removal control by controlling the internal combustion engine such that a temperature of the particulate filter is increased to a predetermined particulate matter removal temperature in order to reduce an amount of particulate matter collected in the particulate filter; and (ii) when it is determined that the amount of particulate matter collected in the particulate filter is smaller than or equal to a predetermined set collection amount, execute ash desorption control by controlling the internal combustion engine such that the temperature of the particulate filter is increased to a predetermined ash desorption temperature and is kept at the ash desorption temperature or higher in order to reduce the amount of ash deposited in the particulate filter. The ash desorption temperature is a temperature suitable for converting the ash into calcium oxide.

An increased pressure loss in the particulate filter due to ash is reduced with a low-cost simple configuration.

### BRIEF DESCRIPTION OF THE DRAWINGS

Features, advantages, and technical and industrial significance of exemplary embodiments of the present disclosure will be described below with reference to the accompanying drawings, in which like numerals denote like elements, and wherein:

FIG. 1 is an overall view of an internal combustion engine;

FIG. 2A is a front view of a particulate filter;

FIG. 2B is a cross-sectional view of the particulate filter;

FIG. 3A is a schematic view that shows a state of ash in the particulate filter;

FIG. 3B is a schematic view that shows a state of ash in the particulate filter;

FIG. 4A is a view that shows a map of an increase dQPMi in the amount of particulate matter collected;

FIG. 4B is a view that shows a map of a reduction. dQPMr in the amount of particulate matter collected;

FIG. 5A is a view that shows a map of an increase dQAi in the amount of ash deposited;

FIG. 5B is a view that shows a map of a reduction dQAr in the amount of ash deposited;

FIG. 6 is a timing chart that illustrates an embodiment of the present disclosure;

FIG. 7A is a timing chart that shows the timing of executing PM removal control and the timing of executing ash desorption control;

FIG. 7B is a timing chart that shows the timing of executing PM removal control and the timing of executing ash desorption control;

FIG. 8 is a flowchart that shows the routine of calculating an estimated amount QPM of particulate matter collected;

FIG. 9 is a flowchart that shows the routine of calculating an estimated amount QA of ash deposited;

FIG. 10 is a flowchart that shows a PM removal control routine;

FIG. 11 is a flowchart that shows an ash desorption control routine;

FIG. 12 is a timing chart that illustrates another embodiment of the present disclosure;

FIG. 13 is a timing chart that illustrates another embodiment of the present disclosure;

FIG. 14 is a view that shows an exhaust aftertreatment apparatus according to further another embodiment of the present disclosure;

FIG. 15 is a timing chart that shows a variation in the concentration CCOX of carbon oxide;

FIG. 16 is a view that shows a map of a reference concentration CCOXR of carbon oxide;

FIG. 17 is a timing chart that shows a variation in a difference dCCOX in the concentration of carbon oxide;

FIG. 18 is a view that shows an exhaust aftertreatment apparatus according to yet another embodiment of the present disclosure;

FIG. 19 is a timing chart that shows a variation in upstream and downstream differential pressure dPF;

FIG. 20 is a view that shows an exhaust aftertreatment apparatus according to further another embodiment of the present disclosure;

FIG. 21 is a timing chart that illustrates the embodiment shown in FIG. 20;

FIG. 22 is a timing chart that illustrates further another embodiment of the present disclosure; and

FIG. 23 is a flowchart that shows an ash desorption control routine according to the embodiment shown in FIG. 22.

### DETAILED DESCRIPTION OF EMBODIMENTS

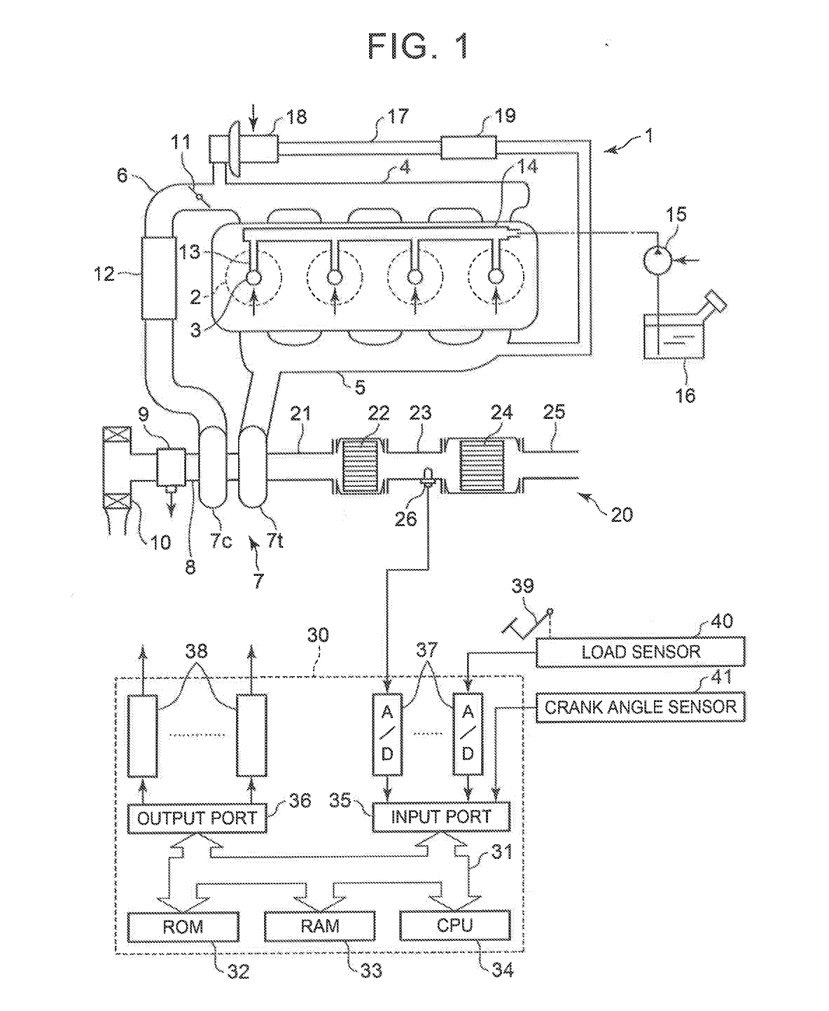

As shown in FIG. 1, reference numeral 1 denotes a main body of a compression ignition internal combustion engine, reference numeral 2 denotes a combustion chamber of each cylinder, reference numeral 3 denotes an electronically controlled fuel injection valve for injecting fuel into a corresponding one of the combustion chambers 2, reference numeral 4 denotes an intake manifold, and reference numeral 5 denotes an exhaust manifold. The intake manifold 4 is coupled to the outlet of a compressor 7c of an exhaust turbocharger 7 via an air intake duct 6. The inlet of the compressor 7c is sequentially coupled to an air flow meter 9 and an air cleaner 10 via an intake air introducing pipe 8. An electrically controlled throttle valve 11 is arranged inside the air intake duct 6. In addition, a cooling device 12 for cooling intake air flowing through the inside of the air intake duct 6 is arranged inside the air intake duct 6. On the other hand, the exhaust manifold 5 is coupled to the inlet of an exhaust turbine 7t of the exhaust turbocharger 7. The outlet of the exhaust turbine 7t is coupled to an exhaust aftertreatment apparatus 20.

Each fuel injection valve 3 is coupled to a common rail 14 via a fuel supply pipe 13. The common rail 14 is coupled to a fuel tank 16 via an electrically-controlled variable displacement fuel pump 15. Fuel inside the fuel tank 16 is supplied into the common rail 14 by the fuel pump 15. The fuel supplied into the common rail 14 is supplied to each fuel injection valve 3 via a corresponding one of the fuel supply pipes 13. A fuel pressure sensor (not shown) is attached to the common rail 14. The fuel pressure sensor detects fuel pressure inside the common rail 14. The discharge rate of fuel from the fuel pump 15 is controlled on the basis of a signal from the fuel pressure sensor such that the fuel pressure inside the common rail 14 coincides with a target pressure. In an embodiment shown in FIG. 1, the fuel is a light oil, iii another embodiment (not shown), the internal combustion engine is a spark ignition internal combustion engine. In this case, fuel is a gasoline.

The exhaust manifold 5 and the intake manifold 4 are coupled to each other via an exhaust gas recirculation (hereinafter, referred to as EGR) passage 17. An electrically controlled EGR control valve 18 is arranged inside the EGR passage 17. A cooling device 19 is arranged around the EGR passage 17. The cooling device 19 is used to cool EGR gas flowing through the inside of the EGR passage 17.

The exhaust aftertreatment apparatus 20 includes an exhaust pipe 21 coupled to the outlet of the exhaust turbine 7t. The exhaust pipe 21 is coupled to the inlet of a catalyst 22. The catalyst 22 has the function of trapping SOx in exhaust gas. The outlet of the catalyst 22 is coupled to the inlet of a wall-flow-type particulate filter 24 via the exhaust pipe 23. The outlet of the particulate filter 24 is coupled to the exhaust pipe 25.

An electronic control unit (ECU) 30 is formed of a digital computer, and includes a read only memory (ROM) 32, a random access memory (RAM) 33, a microprocessor (CPU) 34, an input port 35 and an output port 36, which are connected to one another by a bidirectional bus 31. A temperature sensor 26 is attached to the exhaust pipe 23. The temperature sensor 26 is used to detect the temperature of exhaust gas flowing into the particulate filter 24. The temperature of exhaust gas flowing into the particulate filter 24 indicates the temperature of the particulate filter 24. The output voltage of each of the air flow meter 9 and the temperature sensor 26 is input to the input port 35 via a corresponding one of A/D converters 37. A load sensor 40 is connected to an accelerator pedal 39. The load sensor 40 generates an output voltage proportional to a depression amount of the accelerator pedal 39. The output voltage of the load sensor 40 is input to the input port 35 via a corresponding one of the A/D converters 37. In addition, a crank angle sensor 41 is connected to the input port 35. The crank angle sensor 41 generates an output pulse each time a crankshaft rotates by, for example, 30 degrees. The CPU 34 calculates an engine rotation speed on the basis of an output pulse from the crank angle sensor 41. On the other hand, the output port 36 is connected to each of the fuel injection valves 3, an actuating device of the throttle valve 11, the fuel pump 15 and the EGR control valve 18 via a corresponding one of drive circuits 38. The electronic control unit 30 constitutes PM removal means and ash desorption means.

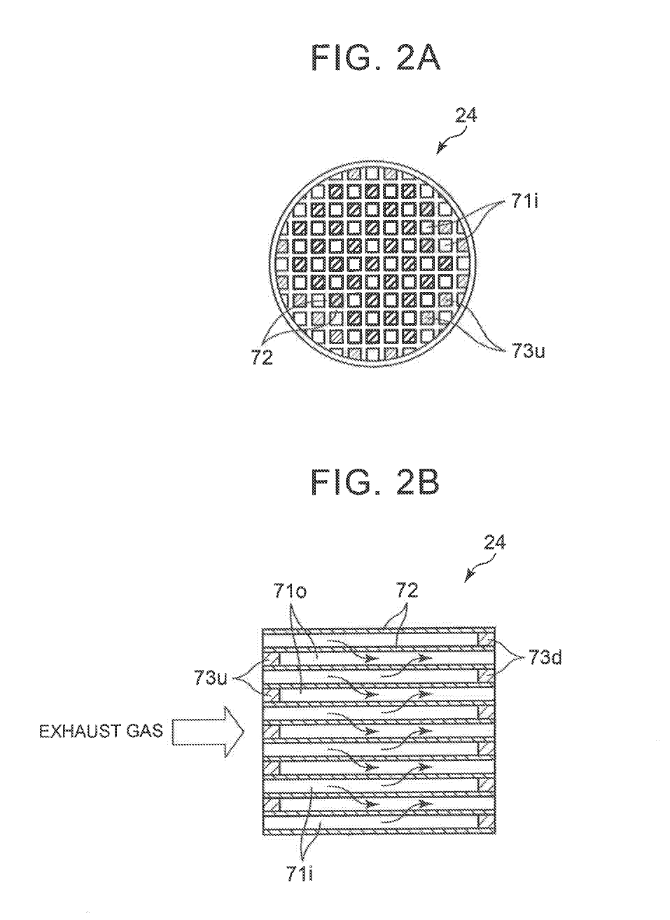

FIG. 2A and FIG. 2B show the structure of the particulate filter FIG shows the front view of the particulate filter 24. FIG. 2B shows the side cross-sectional view of the particulate filter 24. As shown in FIG. 2A and FIG. 2B, the particulate filter 24 has a honeycomb structure, and includes a plurality of exhaust flow passages 71i, 71o and partition walls 72. The plurality of exhaust flow passages 71i, 71o extend parallel to one another. The partition walls 72 partition these exhaust flow passages 71i, 71o. In the embodiment shown in FIG. 2A and FIG. 2B, the exhaust flow passages 71i, 71o include exhaust gas inflow passages 71i and exhaust gas outflow passages 71o. The upstream end of each exhaust gas inflow passage 71i is open, and the downstream end of each exhaust gas inflow passage 71i is closed by a stopper 73d. The upstream end of each exhaust gas outflow passage 71o is closed by a stopper 73u, and the downstream end of each exhaust gas outflow passage 71o is open. In FIG. 2A, the hatched portions indicate the stoppers 73u. Therefore, the exhaust gas inflow passage 71i and the exhaust gas outflow passage 71o are alternately arranged via the thin partition wall 72. In other words, the exhaust gas inflow passages 71i and the exhaust gas outflow passages 71o are arranged such that each exhaust gas inflow passage 71i is surrounded by the four exhaust gas outflow passages 71o and each exhaust gas outflow passage 710 is surrounded by the four exhaust gas inflow passages 71i. In another embodiment (not shown), exhaust flow passages include exhaust gas inflow passages and exhaust gas outflow passages. The upstream end and downstream end of each exhaust gas inflow passage are open. The upstream end of each exhaust gas outflow passage is closed by a stopper, and the downstream end of each exhaust gas outflow passage is open.

The partition walls 72 are made of a porous material, such as cordierite, silicon carbide, silicon nitride, zirconia, titania, alumina, silica, mullite, lithium aluminum silicate and zirconium phosphate. Therefore, as indicated by the arrows in FIG. 2B, exhaust gas initially flows into the exhaust gas inflow passages 71i, and subsequently flows into the adjacent exhaust gas outflow passages 71o through the surrounding partition walls 72. In this way, the partition walls 72 constitute the inner peripheries of the exhaust gas inflow passages 71i.

A catalyst having an oxidizing function is supported on both side faces of the partition walls 72 and surfaces inside fine pores of the partition walls 72. The catalyst having an oxidizing function is composed of a precious metal, such as platinum (Pt), rhodium (Rh) and palladium (Pd). In another embodiment (not shown), a catalyst having an oxidizing function is composed of a composite oxide containing a base metal, such as cerium (Ce), praseodymium (Pr), neodymium (Nd) and lanthanum (La). In further another embodiment (not shown), a catalyst is composed of a combination of a precious metal and a composite oxide.

On the other hand, the catalyst 22 has a honeycomb structure, and includes a plurality of exhaust flow passages separated from each other by a thin base material and extending parallel to one another. Catalyst components are supported on the base material via a carrier made of, for example, alumina. In the embodiment of the present disclosure, the catalyst 22 is an NOx storage-reduction catalyst. The NOx storage-reduction catalyst 22 includes a precious metal catalyst and a basic layer. In the embodiment of the present disclosure, at least one selected from among platinum (Pt), rhodium (Rh) and palladium (Pd) is used as the precious metal catalyst, and at least one selected from among an alkali metal, such as potassium (K), sodium (Na) and cesium (Cs), an alkaline earth metal, such as barium (Ba) and calcium (Ca), a rare earth metal, such as lanthanoid, and a metal that can provide electrons, such as silver (Ag), copper (Cu), iron (Fe) and iridium (Ir), as a component that constitutes the basic layer.

Where the ratio between air and fuel supplied to an intake passage, the combustion chambers 2 or part of an exhaust passage, upstream of a certain position in the exhaust passage, is referred to as the air-fuel ratio of exhaust gas at the corresponding position and the term storage is used as the term that means both absorption and adsorption, the basic layer performs NOx storing and releasing action, that is, the basic layer stores NOx when the air-fuel ratio of influent exhaust gas is lean and releases the stored NOx when the concentration of oxygen in influent exhaust gas decreases.

That is, for example, where platinum (Pt) is used as the precious metal catalyst and barium (Ba) is used as a component of the basic layer, when the air-fuel ratio of influent exhaust gas is lean, that is, when the concentration of oxygen in influent exhaust gas is high, NO contained in influent exhaust gas is oxidized on platinum (Pt) into NO₂. The thus produced NO₂ and NO₂ in influent exhaust gas are subsequently supplied with electrons from platinum and turn into NO₂⁻. Subsequently, the NO₂⁻ disperses within the basic layer in form of nitrate ions NO₃⁻ and turns into a nitrate. In this way, NOx is absorbed into the basic layer in form of nitrate. NO and NO₂ may be temporarily adsorbed and held in the basic layer.

On the other hand, when the air-fuel ratio of influent exhaust gas is set to a rich air-fuel ratio at the time when NOx is absorbed in the basic layer in form of nitrate, the concentration of oxygen in influent exhaust gas decreases, so the reverse reaction proceeds (NO₃⁻→NO₂). As a result, nitrate ions NO₃⁻ in the basic layer are released from the basic layer in form of NO₂. Subsequently, the released NO₂ is reduced into N₂ by a reducing agent, such as HC, CO and H₂, contained in influent exhaust gas. In this way, the NOx storage-reduction catalyst 22 is configured to, when the air-fuel ratio of influent exhaust gas is lean, store NOx and, when the air-fuel ratio of influent exhaust gas is rich, release the stored NOx and reduce the released NOx into N₂.

In the engine main body 1, combustion is being performed under oxygen excess atmosphere. Therefore, because the air-fuel ratio of exhaust gas flowing into the NOx storage-reduction catalyst 22 is lean, NOx in exhaust gas at this time is stored in the NOx storage-reduction catalyst 22. Incidentally, the amount of NOx stored in the NOx storage-reduction catalyst 22 increases with a lapse of time. In the embodiment of the present disclosure, in order to release NOx from the NOx storage-reduction catalyst 22, the air-filter ratio of exhaust gas flowing into the NOx storage-reduction catalyst 22 is temporarily changed to a rich air-fuel ratio.

SOx is also contained in exhaust gas, and the SOx is stored in the NOx storage-reduction catalyst 22 in form of a sulfate BaSO₄ when the air-fuel ratio of influent exhaust gas is lean. That is, the NOx storage-reduction catalyst 22 has the function of trapping SOx in exhaust gas. However, the sulfate BaSO₄ is stable and is hard to be decomposed, so the sulfate BaSO₄ is not decomposed only by merely setting the air-fuel ratio of exhaust gas to a rich air-fuel ratio, and remains as it is. On the other hand, when the air-fuel ratio of exhaust gas flowing into the NOx storage-reduction catalyst 22 is set to a rich air-fuel ratio in a state where the temperature of the NOx storage-reduction catalyst 22 has been increased to an SOx releasing temperature, SOx is released from the NOx storage-reduction catalyst 22. In the embodiment of the present disclosure, in order to release SOx from the NOx storage-reduction catalyst 22, while the temperature of the NOx storage-reduction catalyst 22 is increased to the SOx releasing temperature and is kept at the SOx releasing temperature, the air-fuel ratio of exhaust gas flowing into the NOx storage-reduction catalyst 22 is temporarily changed to a rich air-fuel ratio. The SOx releasing temperature is, for example, 600° C.

In the embodiment of the present disclosure, in order to change the air-fuel ratio of exhaust gas flowing into the NOx storage-reduction catalyst 22 to a rich air-fuel ratio, fuel is injected in combustion stroke or exhaust stroke in addition to main fuel for obtaining engine output power. The additional fuel burns in the combustion chambers 2, in the exhaust passage upstream of the NOx storage-reduction catalyst 22, or in the NOx storage-reduction catalyst 22 while generating almost no engine output power. In another embodiment (not shown), in order to change the air-fuel ratio of exhaust gas flowing into the NOx storage-reduction catalyst 22 to a rich air-fuel ratio, fuel is secondarily added into exhaust gas from a fuel addition valve arranged in the exhaust passage upstream of the NOx storage-reduction catalyst 22.

In the embodiment of the present disclosure, in order to increase the temperature of the NOx storage-reduction catalyst 22, additional fuel is injected from each fuel infection valve 3 in corresponding combustion stroke or exhaust stroke. In another embodiment (not shown), in order to increase the temperature of the NOx storage-reduction catalyst 22, fuel is secondarily added into exhaust gas from a fuel addition valve arranged in the exhaust passage upstream of the NOx storage-reduction catalyst 22.

In addition, particulate matter mainly formed of solid carbon is contained in exhaust gas. This particulate matter is collected by the particulate filter 24. As described above, combustion takes place in the engine main body 1 under oxygen excess atmosphere, so the particulate filter 24 is placed in an oxidizing atmosphere. A precious metal catalyst having an oxidizing function is supported on the particulate filter 24. As a result, particulate matter collected in the particulate filter 24 is sequentially oxidized. However, as the amount of particulate matter that is collected per unit time becomes larger than the amount of particulate matter that is oxidized per unit time, the amount of particulate matter that is collected in the particulate filter 24 increases with a lapse of engine operation time.

In the embodiment of the present disclosure, in order to reduce the amount of particulate matter collected in the particulate filter 24, PM removal control is executed. In the PM removal control, the temperature of the particulate filter 24 is increased to a predetermined PM removal temperature and is kept at the PM removal temperature. As a result, particulate matter in the particulate filter 24 is removed, and a pressure loss in the particulate filter 24 is reduced. The PM removal temperature is, for example, about 610° C.

In the embodiment of the present disclosure, in order to increase the temperature of the particulate filter 24, additional fuel is injected from each fuel injection valve 3 in corresponding expansion stroke or exhaust stroke. In another embodiment (not shown), in order to increase the temperature of the particulate filter 24, fuel is secondarily added into exhaust gas from a fuel addition valve arranged in the exhaust passage upstream of the particulate filter 24.

Incidentally, ash is also contained in exhaust gas, and the ash is also collected by the particulate filter 24 together with particulate matter. It has been verified by the inventors of the present application that ash in this case is mainly formed of calcium carbonate (CaCO₃). Calcium (Ca) originates in engine lubricating oil. Carbon (C) originates in fuel. That is, engine lubricating oil flows into the combustion chambers 2 and burns, and calcium (Ca) in lubricating oil is combined with carbon (C) in fuel, with the result that calcium carbonate (CaCO₃) is produced. Alternatively, calcium oxide (CaO) produced inside the combustion chambers 2 is collected in the particulate filter 24, and subsequently the calcium oxide (CaO) reacts with carbon dioxide (CO₂) in exhaust gas in the particulate filter 24, with the result that calcium carbonate (CaCO₃) is produced.

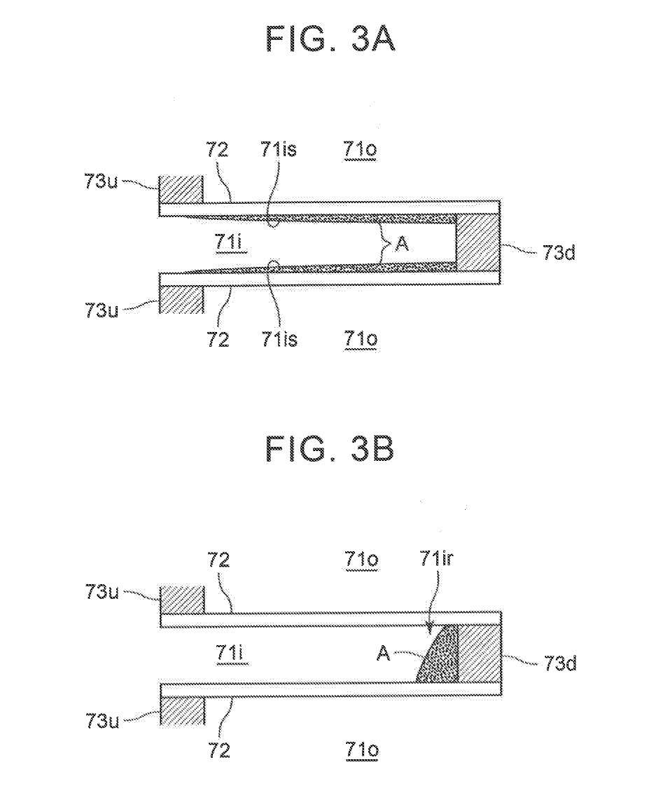

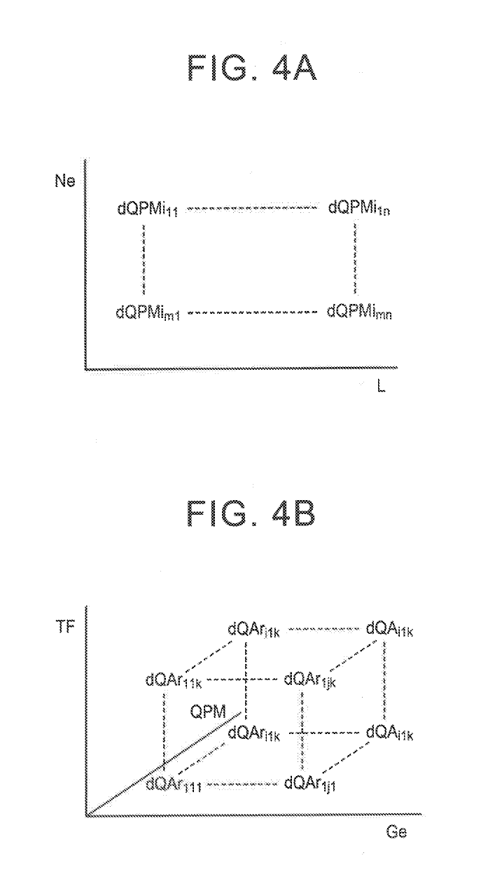

Incidentally, even when PM removal control is executed, ash does not burn or vaporize. That is, ash is not removed from the particulate filter 24, and remains in the particulate filter 24. In this case, as indicated by A in FIG. 3A, ash adheres to an inner periphery 71is of each exhaust gas inflow passage 71i so as to cover the inner periphery 71is. As a result, a pressure loss in the particulate filter 24 increases due to ash.

In this case, ash flows into the particulate filter 24 in form of particles and accumulates on the inner peripheries 71is. As the amount of ash on each inner periphery 71is increases, particles of ash combine with each other to form the shape of a layer. In this process, ash and each partition wall 72 engage with each other through, for example, anchoring, with the result that the layer of ash firmly adheres to each inner periphery 71is. For this reason, for example, even when the flow of exhaust gas acts on ash, it is difficult for the ash to desorb from each inner periphery 71is.

On the other hand, when ash is kept at high temperatures, the ash is converted into calcium oxide (CaO). That is, when calcium carbonate (CaCO₃) that is ash is kept at high temperatures, calcium carbonate (CaCO₃) is decomposed into calcium oxide (CaO) and carbon dioxide (CO₂), and carbon dioxide (CO₂) that is gas is released from the layer of ash. As a result, the particle diameter of ash reduces, and the density of the layer of ash decreases. As a result, bonding between ash particles and engagement of ash with the partition walls 72 are weakened. The bonding energy of calcium oxide (CaO) is higher than the bonding energy of calcium carbonate (CaCO₃). In ionic crystals, a material having a high bonding energy is harder than a material having a low bonding energy. For this reason, when calcium carbonate (CaCO₃) is converted into calcium oxide (CaO), ash becomes hard, and the layer of the ash brittles. Therefore, the ash is allowed to easily desorb from each inner periphery 71is. This has been verified by experiment conducted by the inventors of the present application.

In the embodiment of the present disclosure, order to reduce the amount of ash deposited in the particulate filter 24, ash desorption control is executed. In the ash desorption control, the temperature of the particulate filter 24 is increased to a predetermined ash desorption temperature, and is kept at the ash desorption temperature. In this case, the ash desorption temperature is a temperature suitable for converting ash into calcium oxide (CaO). As a result, an increased pressure loss in the particulate filter 24 due to ash is reduced.

Ash A desorbed from the inner periphery 71is of each exhaust gas inflow passage 71i at the time when the ash desorption control is executed is moved to a back 71ir of the exhaust gas inflow passage 71i by exhaust gas flowing through the exhaust gas inflow passage 71i as shown in FIG. 3B. In this case, the ash A may adhere to the inner periphery 71is at the back 71ir. However, such ash A almost does not influence a pressure loss in the particulate filter 24.

The ash desorption temperature, that is, the temperature suitable for converting ash into calcium oxide (CaO), is, for example, higher than or equal to 450° C. As the ash desorption temperature decreases, a time that is required to complete the ash desorption control becomes longer. On the other hand, if the ash desorption temperature is excessively high, there is a possibility that the amount of fuel per unit time, which is required to increase the temperature of the particulate filter 24, excessively increases or the NOx storage-reduction catalyst 22 or particulate filter 24 breaks. For this reason, the ash desorption temperature is desirably higher than or equal to about 620° C. and lower than or equal to about 800° C., and more desirably about 650° C. In the embodiment of the present disclosure, the ash desorption temperature is set to about 650° C. In the embodiment of the present disclosure, because the PM removal temperature is about 610° C. as described above, the ash desorption temperature is set so as to he higher than the PM removal temperature.

On the other hand, the above-described ash decomposition reaction is facilitated by the catalyst having an oxidizing function on the particulate filter 24. However, when a large amount of particulate matter is collected in the particulate filter 24, it is difficult for ash to contact with the catalyst having an oxidizing function. As a result, the ash decomposition reaction becomes difficult to occur, with the result that it becomes difficult for ash to desorb from the inner peripheries 71is.

In the embodiment of the present disclosure, it is determined whether the amount of particulate matter collected in the particulate filter 24 is smaller than or equal to a predetermined set collection amount, and the ash desorption control is executed when it is determined that the amount of particulate matter collected in the particulate filter 24 is smaller than or equal to the set collection amount. As a result, ash reliably desorbs from the inner peripheries 71is.

In the embodiment of the present disclosure, the amount of particulate matter collected in the particulate filter 24 is estimated on the basis of an engine operating state. Specifically, an estimated amount QPM of particulate matter collected is calculated by using the following mathematical expression. In the following mathematical expression, dQPMi denotes an increase in the amount of particulate matter collected per unit time, and dQPMr denotes a reduction in the amount of particulate matter collected per unit time.

QPM=QPM+dQPMi−dQPMr

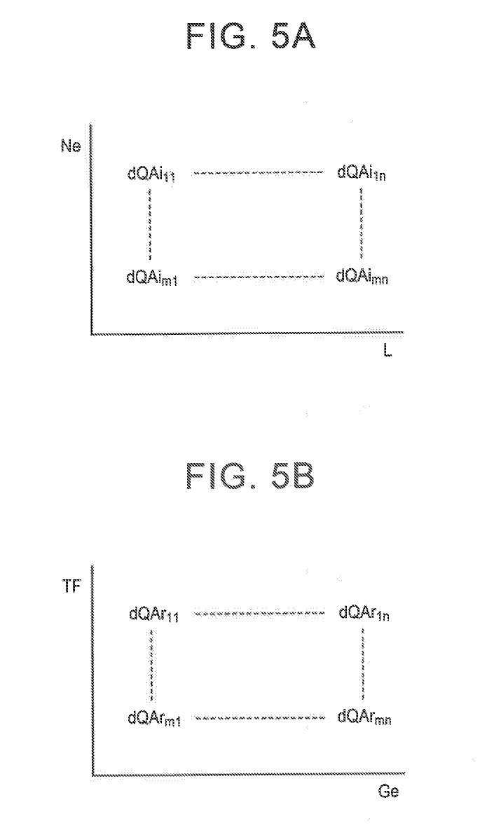

The increase dQPMi in the amount of particulate matter collected is calculated on the basis of the engine operating state, that is, for example, an engine load L and an engine rotation speed Ne. In the embodiment of the present disclosure, the engine load L is represented by the depression amount of an accelerator pedal 39. The increase dQPMi is stored in the ROM 32 in advance in form of a map shown in FIG. 4A as a function of the engine load L and the engine rotation speed Ne. On the other hand, the reduction dQPMr in the amount of particulate matter collected is calculated on the basis of the engine operating state, that is, for example, the temperature TF of the particulate filter 24 and an exhaust gas amount Ge flowing into the particulate filter 24. In the embodiment of the present disclosure, the exhaust gas amount Ge is represented by an intake air amount. The reduction dQPMr is stored in the ROM 32 in advance in form of a map shown in FIG. 4B as a function of the filter temperature TF and the exhaust gas amount Ge.

Under the above conditions, as the estimated amount QPM of particulate matter collected exceeds a predetermined first PM set value QPM1, the PM removal control is started. When the PM removal control is executed, the estimated amount QPM of particulate matter collected reduces. As the estimated amount QPM of particulate matter collected becomes smaller than or equal to a predetermined second PM set value QPM2, the PM removal control is ended.

In the embodiment of the present disclosure, the amount of ash deposited in the particulate filter 24 is estimated on the basis of the engine operating state. Specifically, an estimated amount QA of ash deposited is calculated by using the following mathematical expression. In the following mathematical expression, dQAi denotes an increase in the amount of ash deposited per unit time, and dQAr denotes a reduction in the amount of ash deposited per unit time.

QA=Qa+dQAi−dQAr

The increase dQAi in the amount of ash deposited is calculated on the basis of the engine operating state, that is, for example, the engine load L and the engine rotation speed Ne. The increase dQAi is stored in the ROM 32 in advance in form of a map shown in FIG. 5A as a function of the engine load L and the engine rotation speed Ne. On the other hand, the reduction dQAr in the amount of ash deposited is calculated on the basis of the engine operating state, that is, for example, the temperature TF of the particulate filter 24, the exhaust gas amount Ge flowing into the particulate filter 24, and the estimated amount QPM of particulate matter collected. The reduction dQAr is stored in the ROM 32 in advance in form of a map shown in FIG. 5B as a function of the filter temperature TF, the exhaust gas amount Ge and the estimated amount QPM of particulate matter collected.

Under the above conditions, when the estimated amount QA of ash deposited exceeds a predetermined first ash set value QA1 and the estimated amount QPM of particulate matter collected is smaller than or equal to a third PM set value QPM3 corresponding to the above-described set collection amount, the ash desorption control is started. Therefore, conceptually, it is determined whether the amount of ash deposited in the particulate filter 24 is larger than a predetermined first set deposition amount and it is determined that the amount of particulate matter collected in the particulate filter 24 is smaller than or equal to a set collection amount and the amount of ash deposited in the particulate filter 24 is larger than the first set deposition amount, the ash desorption control is executed. In the embodiment of the present disclosure, when the estimated amount QA of ash deposited, which is calculated on the basis of the engine operating state, is larger than the first ash set value QA1, it is determined that the amount of ash deposited in the particulate filter 24 is larger than the first set deposition amount. When the estimated amount QPM of particulate matter collected, which is calculated on the basis of the engine operating state, is smaller than or equal to the third PM set value QPM3, it is determined that the amount of particulate matter collected in the particulate filter 24 is smaller than or equal to the set collection amount.

When the ash desorption control is executed, the estimated amount QA of ash deposited reduces. When the estimated amount QA of ash deposited becomes smaller than or equal to a predetermined second ash set value QA2, the ash desorption control is ended. Therefore, conceptually, it is determined whether the amount of ash deposited is smaller than or equal to a predetermined second set deposition amount during ash desorption control, and the ash desorption control is ended when it is determined that the amount of ash deposited is smaller than or equal to the second set deposition amount during ash desorption control. In the embodiment of the present disclosure, when the estimated amount QA of ash deposited, which is calculated on the basis of the engine operating state, is smaller than or equal to the second ash set value QA2, it is determined that the amount of ash deposited in the particulate filter 24 is smaller than or equal to the second set deposition amount.

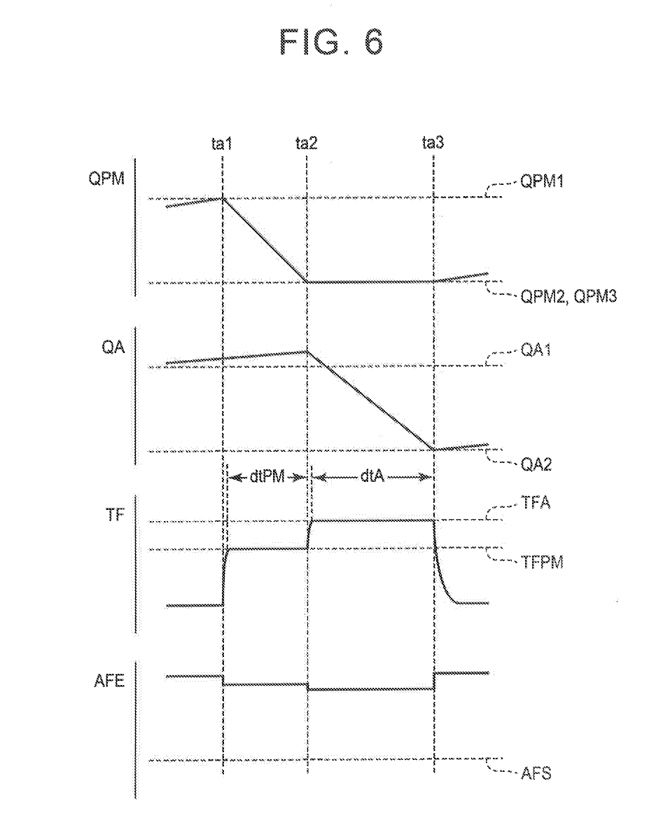

That is, as shown in FIG. 6, as the estimated amount QPM of particulate matter collected exceeds the first PM set value QPM1 at time ta1, the PM removal control is started. As a result, the filter temperature TF is increased to the PM removal temperature TFPM, and is kept at the PM removal temperature TFPM. In this case, the air-fuel ratio APE of exhaust gas flowing into the particulate filter 24 slightly decreases while being kept at an air-fuel ratio leaner than a stoichiometric air-fuel ratio AFS.

When the PM removal control is executed, the estimated amount QPM of particulate matter collected reduces. Subsequently, as the estimated amount QPM of particulate matter collected becomes smaller than or equal to the second PM set value QPM2 at time ta2, the PM removal control is ended. In the embodiment of the present disclosure, the second PM set value QPM2 is zero.

In the embodiment of the present disclosure, the third PM set value QPM3 is set so as to be equal to the second PM set value QPM2. Therefore, at time ta2, the estimated amount QPM of particulate matter collected is smaller than or equal to the third PM estimated value QPM3. On the other hand, at time ta2, the estimated amount QA of ash deposited is larger than the first ash set value QA1. For this reason, at time ta2, the ash desorption control is started. That is, the filter temperature TF is further increased to the ash desorption temperature TFA, and is kept at the ash desorption temperature TFA. In this case, the air-fuel ratio APE of exhaust gas further decreases while being kept at an air-fuel ratio leaner than the stoichiometric air-fuel ratio AFS. Particulate matter flowing into the particulate filter 24 during ash desorption control is immediately oxidized and removed. Therefore, during ash desorption control, the estimated amount QPM particulate matter collected is kept at zero.

When the ash desorption control is executed, the estimated amount QA of ash deposited reduces. Subsequently, as the estimated amount QA of ash deposited becomes smaller than or equal to the second ash set value QA2 at time ta1, the ash desorption control is ended. That is, the filter temperature TF is returned to the original temperature, and the air-fuel ratio AFE of exhaust gas is returned to the original air-fuel ratio.

In the example shown in FIG. 6, a time dtA during which the filter temperature TF is kept so as to be higher than or equal to the ash desorption temperature TFA in ash desorption control is longer than a time dtPM during which the filter temperature TF is kept so as to be higher than or equal to the PM removal temperature TFPM in PM removal control. This is because conversion of calcium carbonate (CaCO₃) into calcium oxide (CaO) does not sufficiently proceed in a short period of time. That is, in the example shown in FIG. 6, even when the filter temperature IF is kept at the temperature TFA higher than the PM removal temperature TFPM in ash desorption control, it is difficult to sufficiently obtain ash desorption action in the case where the holding time dtA is equal to or shorter than the holding time dtPM of the. PM removal control. In consideration of the fact that the holding time dtA of the ash desorption control is allowed to be extended when the ash desorption temperature TFA is decreased and the holding time dtA is allowed to be shortened when the ash desorption temperature TFA is increased, in the example shown in FIG. 6, there can be a view that the ash desorption temperature TFA is set such that the holding time dtA of the ash desorption control is longer than the holding time dtPM of the PM removal control. In another embodiment (not shown), the ash desorption temperature TFA is set to about 800° C. Thus, the holding time dtA of the ash desorption control is made shorter than the holding time dtPM of the PM removal control. In other words, in this embodiment, the ash desorption temperature TFA is set such that the holding time dtA of the ash desorption control is shorter than the holding time dtPM of the PM removal control.

In the embodiment of the present disclosure, as the estimated amount QPM of particulate matter collected becomes smaller than or equal to the second PM set value QPM2, the PM removal control is ended, and, as the estimated amount QPM of particulate matter collected becomes smaller than or equal to the third PM set value QPM3, the ash desorption control is started. The second PM set value QPM2 and the third PM set value QPM3 are substantially equal to each other. Therefore, in the embodiment of the present disclosure, as the PM removal control is ended, the ash desorption control is started. Alternatively, there can be a view that it is determined that the amount of particulate matter collected in the particulate filter is smaller than or equal to the set collection amount at the time when the PM removal control is ended. In any case, the ash desorption control is started at the time when the temperature of the particulate filter 24 is relatively high, so it is possible to efficiently increase the temperature of the particulate filter 24.

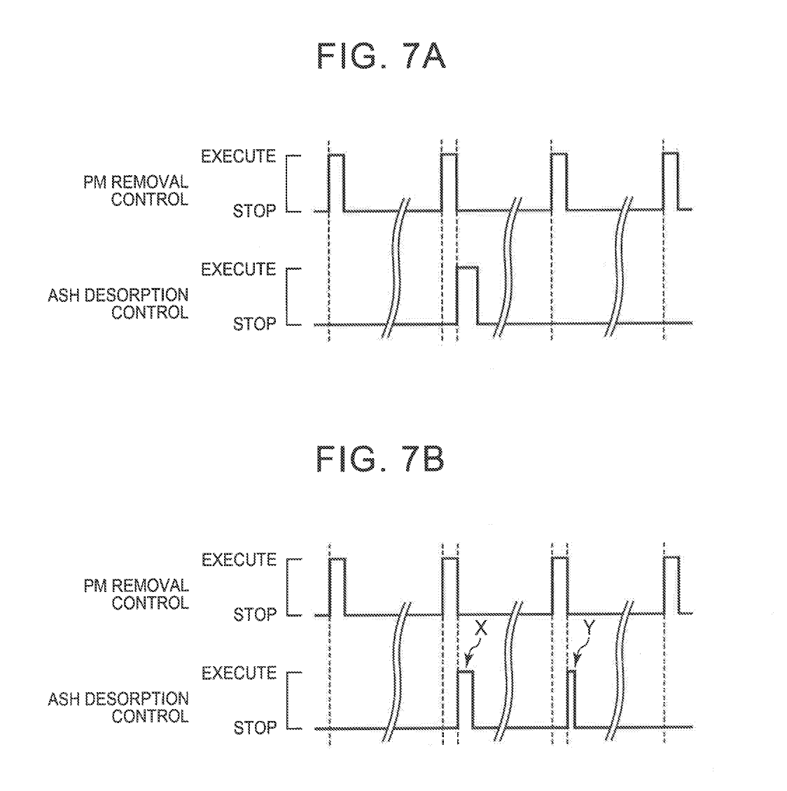

Incidentally, the amount of ash that is collected in the particulate filter 24 per unit time is considerably smaller than the amount of particulate matter that is collected in the particulate filter 24 per unit time. For this reason, a frequency at which the ash desorption control is executed is lower than a frequency at which the PM removal control is executed. That is, as shown in FIG. 7A, each time the PM removal control is executed multiple times, the ash desorption control is executed once. In another embodiment (not shown), each time the PM removal control is executed once, the ash desorption control is executed once.

On the other hand, the holding time of the ash desorption control is relatively long, so the ash desorption control may be intermitted because of some reasons. In this case, the ash desorption control is stopped in a state where the estimated amount of ash deposited in the particulate filter 24 is larger than the second ash set value QA2. In the embodiment of the present disclosure, subsequently, when the estimated amount QPM of particulate matter collected in the particulate filter 24 becomes smaller than or equal to the third PM set value QPM3, the ash desorption control is executed even when the estimated amount QA of ash deposited in the particulate filter is smaller than the first ash set value QA1. That is, as indicated by X in FIG. 7B, when the ash desorption control is intermitted, the ash desorption control is resumed at the time when the next PM removal control is ended as indicated by Y. As a result, an increased pressure loss in the particulate filter 24 due to ash is reliably reduced, in resumed ash desorption control, as the estimated amount QA of ash deposited becomes smaller than or equal to the second ash set value QA2, the ash desorption control is ended.

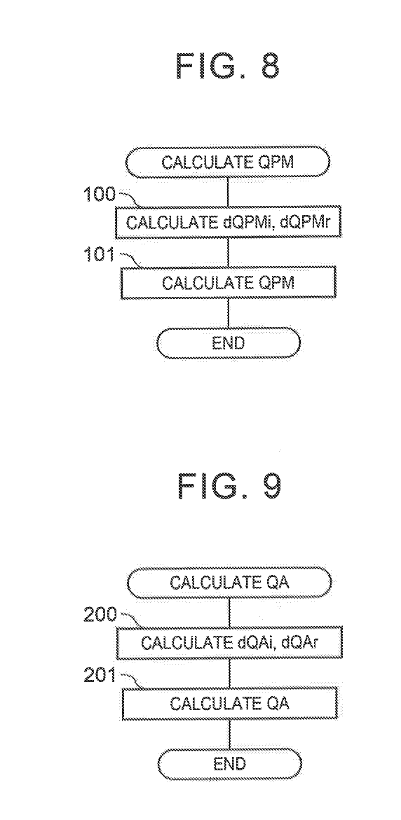

FIG. 8 shows the routine of calculating an estimated amount QPM of particulate matter collected according to the embodiment of the present disclosure. This routine is repeatedly executed by an interrupt at predetermined set intervals. As shown in FIG. 8, in step 100, an increase dQPMi and reduction dQPMr in the amount of particulate matter collected are respectively calculated with the use of the map shown in FIG. 4A and the map shown in FIG. 4B. Subsequently, in step 101, an estimated amount QPM of particulate matter collected is calculated (QPM=QPM+dQPMi−dQPMr).

FIG. 9 shows the routine of calculating an estimated amount QA of ash deposited according to the embodiment of the present disclosure. This routine is repeatedly executed by an interrupt at predetermined set intervals. As shown in FIG. 9, in step 200, an increase dQAi and reduction dQAr in the amount of ash deposited are respectively calculated with the use of the map shown in FIG. 5A and the map shown in FIG. 5B. Subsequently, in step 201, an estimated amount QA of ash deposited is calculated (QA=QA+dQAi−dQAr).

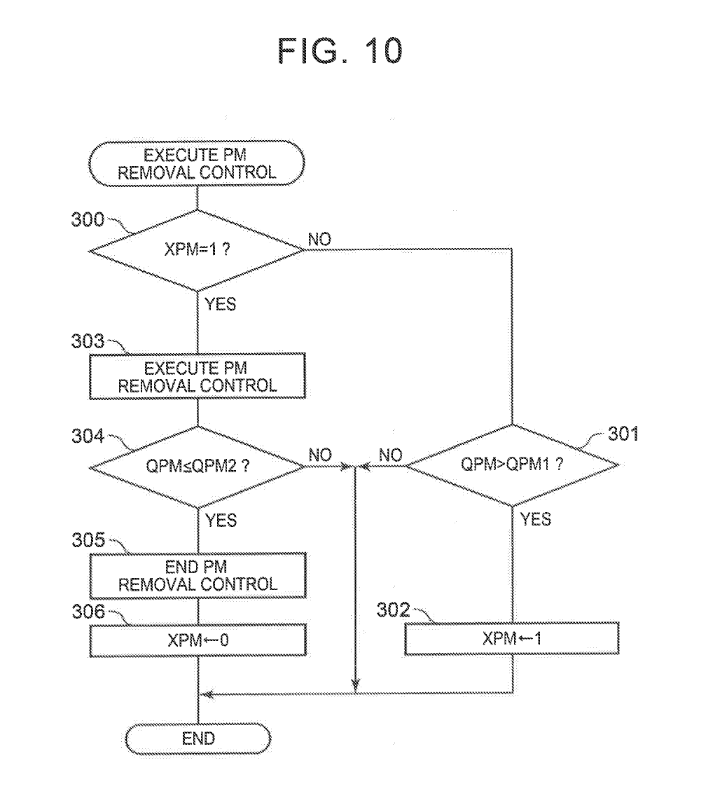

FIG. 10 shows the routine of executing the PM removal control according to the embodiment of the present disclosure. This routine is repeatedly executed by an interrupt at predetermined set intervals. As shown in FIG. 10, in step 300, it is determined whether a flag XPM is set. The flag XPM is set (XPM=1) when the PM removal control should be executed; otherwise, the flag XPM is reset (XPM=0). When the flag XPM is reset, the process proceeds to step 301, in step 301, it is determined whether the estimated amount QPM of particulate matter collected is larger than the first PM set value QPM1. When QPM≦QPM1, the processing cycle is ended. When QPM>QPM1, the process proceeds to step 302, and the flag XPM is set (XPM=1).

When the flag XPM is set, the process proceeds from step 300 to step 303, and the PM removal control is executed. Subsequently, in step 304, it is determined whether the estimated amount QPM of particulate matter collected is smaller than or equal to the second PM set value QPM2. When QPM>QPM2, the processing cycle is ended. When QPM≦QPM2, the process proceeds to step 305, and the PM removal control is ended. Subsequently, in step 306, the flag XPM is reset (XPM=0).

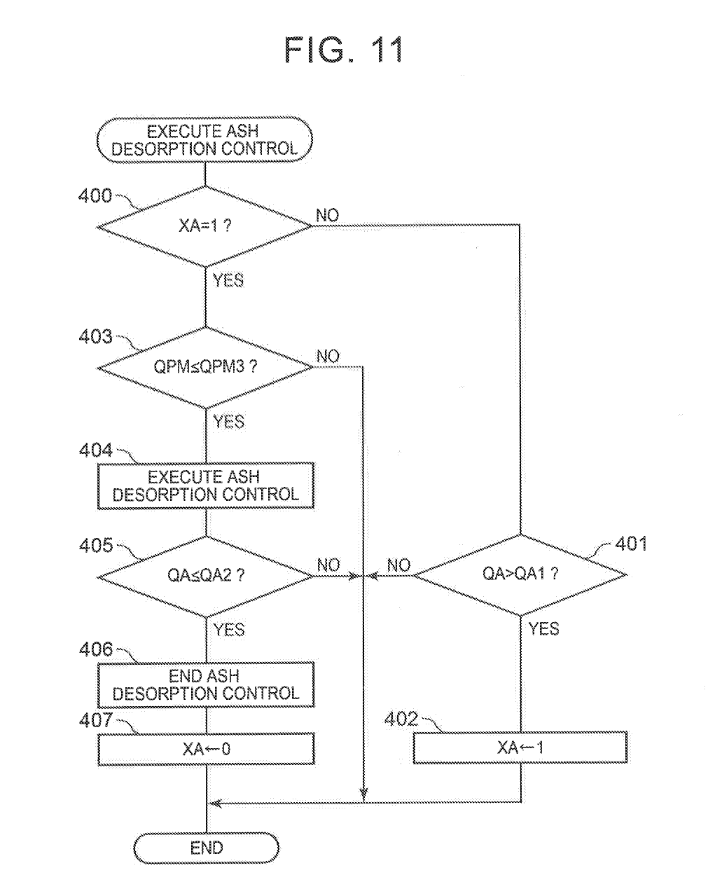

FIG. 11 shows the routine of executing the ash desorption control according to the embodiment of the present disclosure. This routine is repeatedly executed by an interrupt at predetermined set intervals. As shown in FIG. 11, in step 400, it is determined whether a flag XA is set. The flag XA is set (XA=1) when the ash desorption control should be executed; otherwise, the flag XA is reset (XA=0). When the flag XA is reset, the process proceeds to step 401. In step 401, it is determined whether the estimated amount QA of ash deposited is larger than the first ash set value QA1. When QA≦QA1, the processing cycle is ended. When QA>QA1, the process proceeds to step 402, and the flag XA is set (XA=1).

When the flag XA is set, the process proceeds from step 400 to step 403. In step 403, it is determined whether the estimated amount QPM of particulate matter collected is smaller than or equal to the third PM set value QPM3. When QPM>QPM3, the processing cycle is ended. When QPM≦QPM3, the process proceeds to step 404, and the ash desorption control is executed. Subsequently in step 405, it is determined whether the estimated amount QA of ash deposited is smaller than or equal to the second ash set value QA2. When QA>QA2, the processing cycle is ended. When QA≦QA2, the process proceeds to step 406, and the ash desorption control is ended. Subsequently, in step 407, the flag XA is reset (XA=0).

When the ash desorption control is intermitted, the flag XA is kept in a set state. For this reason, when the routine of FIG. 11 is executed thereafter, the process proceeds from step 400 to step 403, and, when the estimated amount QPM of particulate matter collected is smaller than or equal to the third PM set value QPM3, the ash desorption control is resumed.

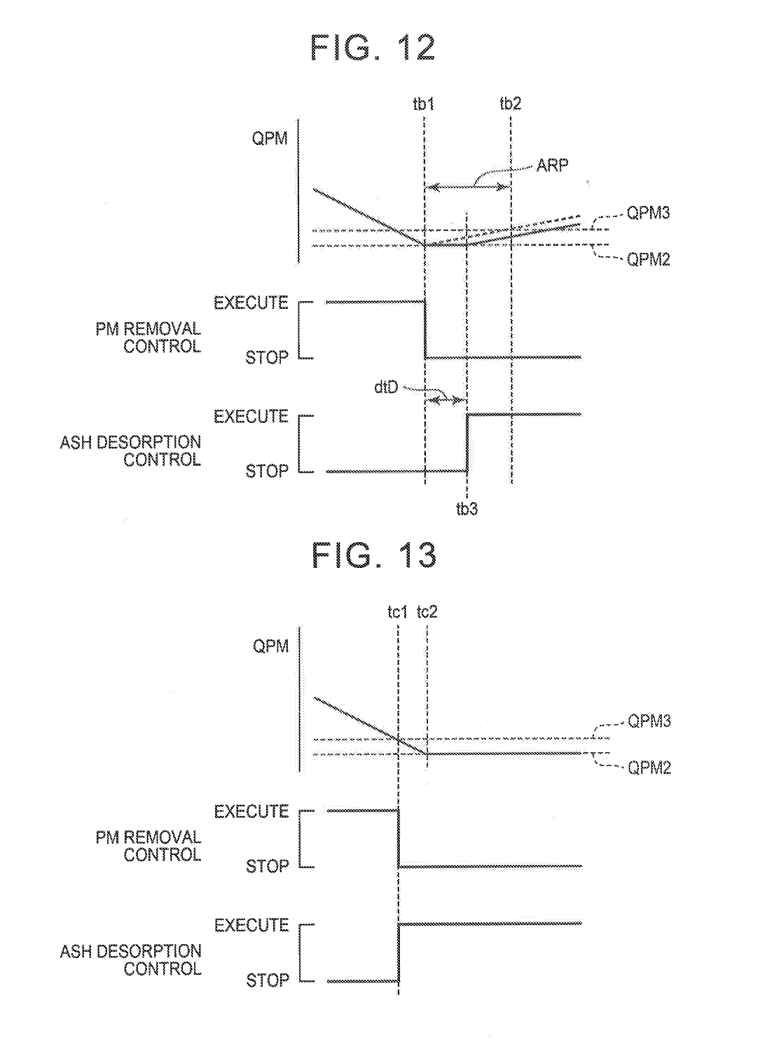

Next, another embodiment of the present disclosure will be described. In the above-described embodiment, the third PM set value QPM3 is set so as to be substantially equal to the second PM set value QPM2. In contrast, in another embodiment of the present disclosure, the third PM set value QPM3 is set so as to be larger than the second PM set value QPM2. There are two ideas for the PM removal control and the ash desorption control in this case. These ideas will be described one by one with reference to FIG. 12 and FIG. 13.

Initially, in the embodiment shown in FIG. 12, as the estimated amount QPM of particulate matter collected becomes smaller than or equal to the second PM set value QPM at time tb1, the PM removal control is ended. In FIG. 12, the estimated amount QPM of particulate matter collected in the case where the ash desorption control is not started after the PM removal control is ended is indicated by the dashed line. The estimated amount QPM of particulate matter collected, which is indicated by the dashed line, gradually increases from time tb1, and becomes larger than or equal to the third PM set value QPM3 at time tb2, That is, in a period ARP from time tb1 to time tb2, the estimated amount QPM of particulate matter collected is smaller than or equal to the third PM set value QPM3. Therefore, it is not required to start the ash desorption control immediately after the PM removal control is ended. When the ash desorption control is started within the period ARP, ash is reliably desorbed. In the embodiment shown in FIG. 12, the ash desorption control is started at time tb3 within the period ARP. In other words, after a delay time dtD has elapsed from the end of the PM removal control, the ash desorption control is started. The estimated amount QPM of particulate matter collected in this case is indicated by the continuous line in FIG. 12. Where the delay time dtD is zero, the estimated amount QPM of particulate matter collected is similar to that of the embodiment shown in FIG. 6.

On the other hand, in the embodiment shown in FIG. 13, at time tc1 at which the PM removal control is being executed, the estimated amount QPM of particulate matter collected becomes smaller than or equal to the third PM set value QPM3. At this time, although the estimated amount QPM of particulate matter collected is larger than the second PM set value QPM2, the PM removal control is intermitted or ended, and the ash desorption control is started. During ash desorption control as well, particulate matter in the particulate filter 24 is oxidized and removed. Therefore, the estimated amount QPM of particulate matter collected continues to reduce even when the ash desorption control is started, and reaches the second PM set value QPM2, that is, zero, at time tc2.

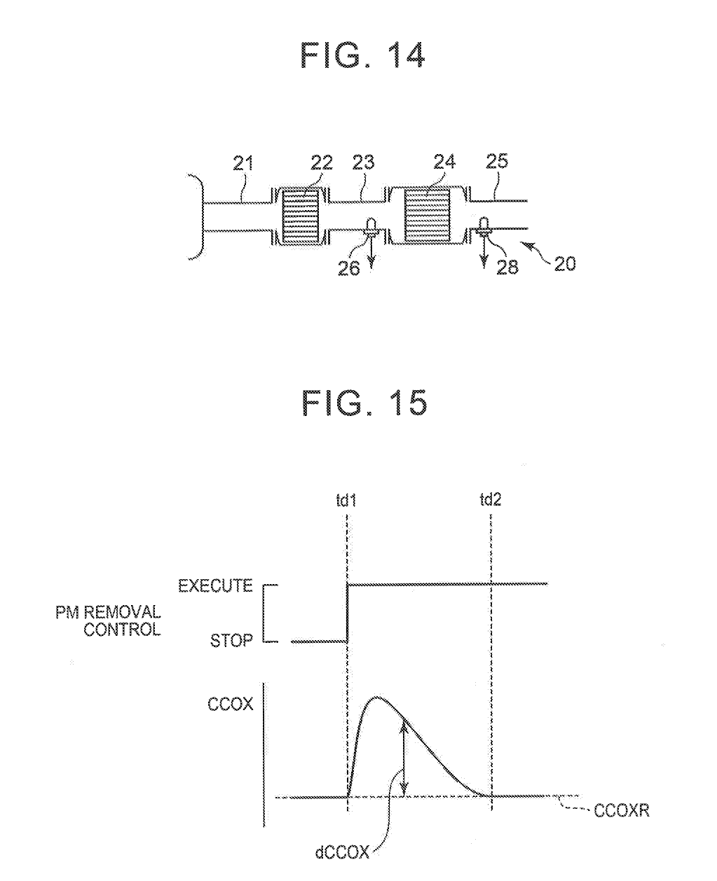

FIG. 14 shows further another embodiment of the present disclosure. In the embodiment shown in FIG. 14, a carbon oxide concentration sensor 28 is provided in the exhaust pipe 25. The carbon oxide concentration sensor 28 is used to detect the concentration of carbon oxides (carbon monoxide (CO) and carbon dioxide (CO₂)) in exhaust gas flowing out from the particulate filter 24.

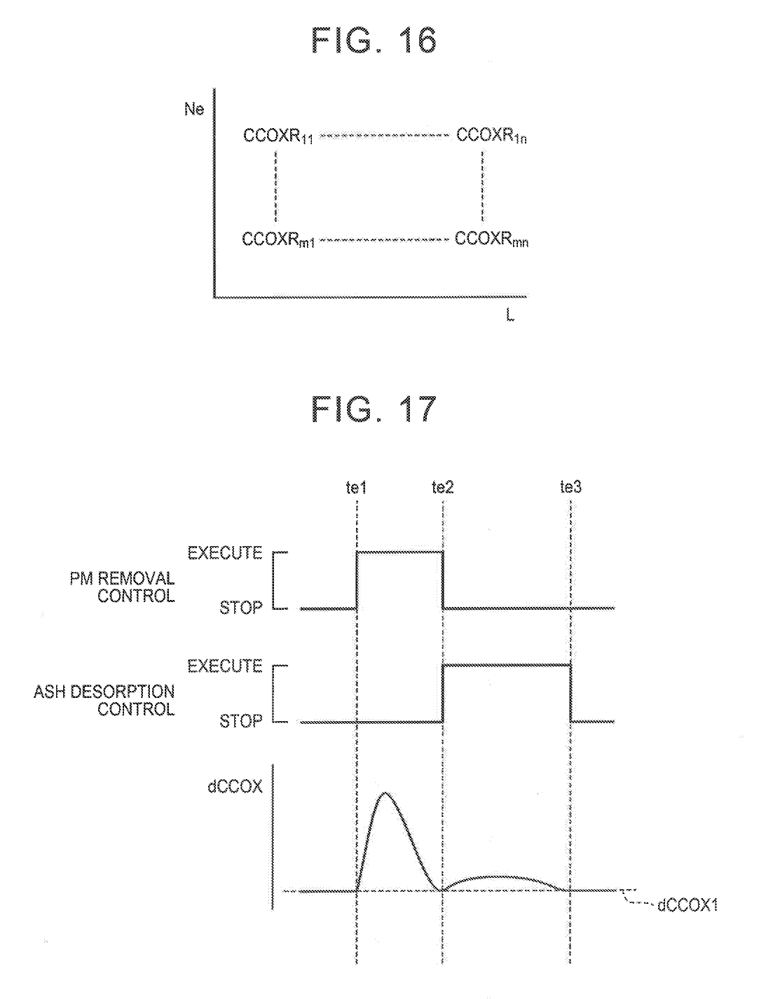

FIG. 15 shows a variation in the concentration CCOX of carbon oxides in exhaust gas flowing out ftom the particulate filter 24 at the time when the PM removal control is continuously executed. In FIG. 15, CCOXR indicates the concentration of carbon dioxides in exhaust gas flowing out from the particulate filter 24 during ordinary operation where the PM removal control or the ash desorption control is not being executed, that is, a reference carbon oxide concentration. As the PM removal control is started at time td1 in FIG. 15, particulate matter in the particulate filter 24 begins to be oxidized, so the concentration CCOX of carbon oxides increases by an increase dCCOX with respect to the reference carbon oxide concentration CCOXR. With a lapse of time, the amount of particulate matter that is oxidized reduces, so the increase dCCOX gradually reduces, and becomes zero at time td2. That is, the concentration CCOX of carbon oxides coincides with the reference carbon oxide concentration CCOXR. The reference carbon oxide concentration CCOXR can vary in response to the engine operating state, that is, for example, the engine load L and the engine rotation speed Ne. The reference carbon oxide concentration CCOXR is stored in the ROM 32 in advance in form of a map shown in FIG. 16 as a function of the engine load L and the engine rotation speed Ne.

In the embodiment shown in FIG. 6, when the estimated amount QPM of particulate matter collected is smaller than or equal to the third PM set value QPM3, it is determined that the amount of particulate matter collected in the particulate filter 24 is smaller than or equal to the set collection amount. That is, the start timing of the ash desorption control is determined on the basis of the estimated amount QPM of particulate matter collected. In contrast, in the embodiment shown in FIG. 14, the start timing of the ash desorption control is determined on the basis of the increase dCCOX in the concentration of carbon oxides. That is, it is determined that the amount of particulate matter collected in the particulate filter is smaller than or equal to the set collection amount when an increase, caused by the PM removal control, in the concentration of carbon oxides in exhaust gas flowing out from the particulate filter 24 during PM removal control becomes smaller than or equal to a predetermined set value.

That is, as the PM removal control is started at time tc1 in FIG. 17, the increase dCCOX in the concentration of carbon oxides increases. With a lapse of time, the increase dCCOX reduces, and subsequently becomes smaller than or equal to a value dCCOX1 corresponding to the above-described set value at time te2. In the embodiment shown in FIG. 17, the PM removal control is ended at this time, and the ash desorption control is started. As a result, the start timing of the ash desorption control is allowed to be reliably set to the timing at which the amount of particulate matter collected in the particulate filter 24 is small, so it is possible to reliably desorb ash from the inner peripheries 71is.

As shown in FIG. 17, as the ash desorption control is started, the increase dCCOX increases again. This is because carbon dioxide (CO₂) is released as a result of conversion of calcium carbonate (CaCO₃) into calcium oxide (CaO). Subsequently, the increase dCCOX becomes smaller than the value dCCOX1 again at time te3,

In the embodiment shown in FIG. 6, when the estimated amount QA of ash deposited is smaller than or equal to the second ash set value QA2, it is determined that the amount of ash deposited in the particulate filter 24 is smaller than or equal to the second set deposition amount. That is, the end timing of the ash desorption control is determined on the basis of the estimated amount QA of ash deposited. In contrast, in another embodiment (not shown), the end timing of the ash desorption control is determined on the basis of the increase dCCOX in the concentration of carbon oxides. That is, when an increase in the concentration of carbon oxides in exhaust gas flowing out from the particulate filter 24 during ash desorption control is smaller than or equal to another predetermined set value, it is determined that the amount of ash deposited in the particulate falter 24 is smaller than or equal to the second set deposition amount.

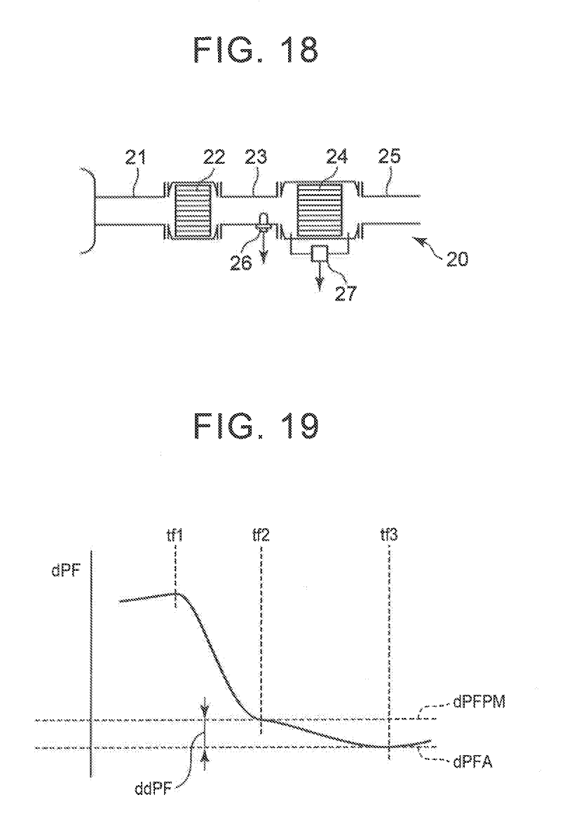

FIG. 18 shows further another embodiment of the present disclosure. In the embodiment shown in FIG. 18, a pressure loss sensor is provided. The pressure loss sensor is used to detect a pressure loss in the particulate filter 24. In the embodiment shown in FIG. 18, a pressure loss in the particulate filter 24 is represented by an upstream and downstream differential pressure of the particulate filter 24, and the pressure loss sensor is a differential pressure sensor 27 for detecting the upstream and downstream differential pressure of the particulate filter 24. In another embodiment (not shown), a pressure loss in the particulate filter 24 is represented by an engine back pressure, that is, a pressure in the exhaust passage upstream of the particulate filter 24, and the pressure loss sensor is a pressure sensor provided in the exhaust passage upstream of the particulate filter 24.

In the embodiment shown in FIG. 6, when the estimated amount QA of ash deposited is smaller than or equal to the second ash set value QA2, it is determined that the amount of ash deposited in the particulate filter 24 is smaller than or equal to the second set deposition amount. That is, the end timing of the ash desorption control is determined on the basis of the estimated amount QA of ash deposited. In contrast, in the embodiment shown in FIG. 19, the end timing of the ash desorption control is determined on the basis of the upstream and downstream differential pressure of the particulate filter 24.

As described above, when the ash desorption control is being executed, almost no particulate matter is accumulated in the particulate filter 24. For this reason, a pressure loss in the particulate filter 24 during ash desorption control is due to the particulate filter 24 itself and ash, so the pressure loss represents the amount of ash deposited.

In the embodiment shown in FIG. 18, when the pressure loss in the particulate filter 24 becomes smaller than or equal to a predetermined threshold, it is determined that the amount of ash deposited is smaller than or equal to the second set deposition amount. That is, when the upstream and downstream differential pressure dPF of the particulate filter 24 is smaller than or equal to a set differential pressure dPFA corresponding to the threshold, the ash desorption control is ended.

FIG. 19 schematically shows a variation in the upstream and downstream differential pressure dPF of the particulate filter 24. As shown in FIG. 19, as the PM removal control is started at time tf1, the upstream and downstream differential pressure dPF decreases. Subsequently, at time tf2, the PM removal control is ended, and the ash desorption control is started. The upstream and downstream differential pressure dPF at this time is indicated by a value dPFPM. Subsequently, as the upstream and downstream differential pressure dPF becomes smaller than or equal to the set differential pressure dPFA at time tf3, the ash desorption control is ended. As shown in FIG. 19, the set differential pressure dPF is set so as to be smaller by ddPF than the upstream and downstream differential pressure dPFPM at the time when the PM removal control is ended. As a result, an increased pressure loss in the particulate filter 24 due to ash is reliably recovered.

In the embodiment shown in FIG. 6, when the estimated amount QA of ash deposited is larger than the first ash set value QA1, it is determined that the amount of ash deposited in the particulate filter 24 is larger than the first set deposition amount. That is, the, start timing of the ash desorption control is determined on the basis of the estimated amount QA of ash deposited. In contrast, in another embodiment (not shown), the start timing of the ash desorption control is determined on the basis of the upstream and downstream differential pressure of the particulate filter 24. That is, when the pressure loss in the particulate filter 24 at the time when the PM removal control is ended is larger than another predetermined threshold, it is determined that the amount of ash deposited in the particulate filter 24 is larger than the first set deposition amount.

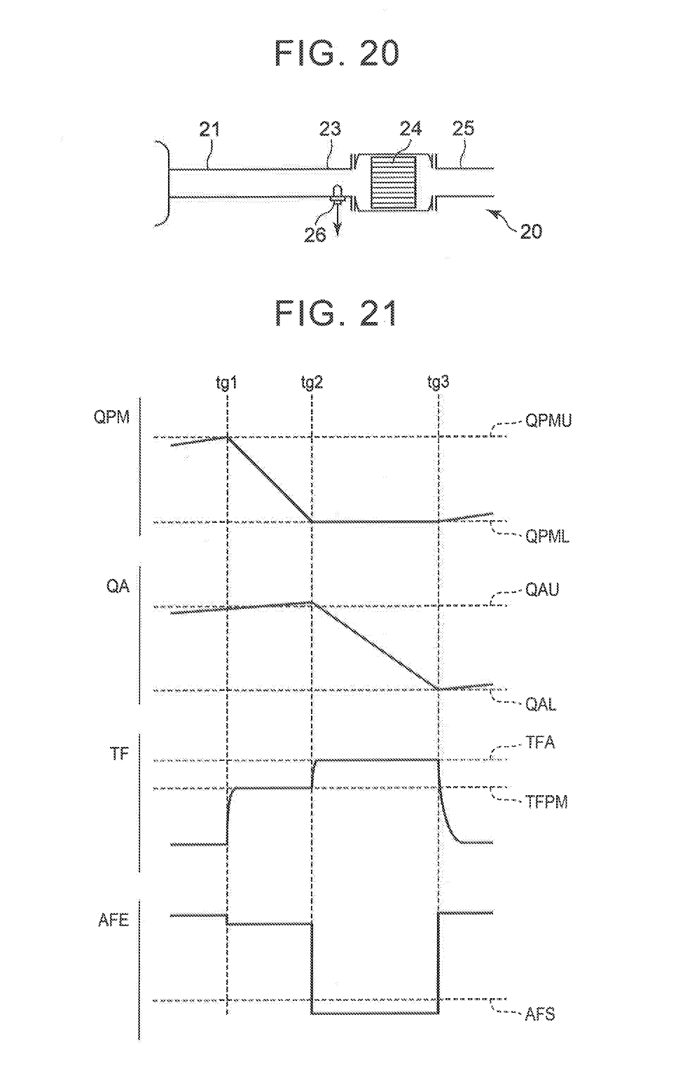

FIG. 20 shows further another embodiment of the present disclosure. In the embodiment shown in FIG. 20, no catalyst 22, such as an NOx storage-reduction catalyst having the function of trapping SOx in exhaust gas, is provided, and the exhaust pipe 21 is coupled to the inlet of the particulate filter 24. In this case, the concentration of SOx in exhaust gas emitted from the engine main body 1, that is, for example, the concentration of SOx in exhaust gas flowing into the exhaust manifold 5, and the concentration of SOx in exhaust gas flowing into the particulate filter 24 are substantially equal to each other.

In the embodiment shown in FIG. 20, it has been verified by the inventors of the present application that ash is mainly formed of calcium carbonate (CaCO₃) and calcium sulfate (CaSO₄). This is because of the following reason. That is, in the embodiment shown in FIG. 20, calcium carbonate (CaCO₃) that is ash is collected by the particulate filter 24, and exhaust gas containing SOx flows into the particulate filter 24. Because the particulate filter 24 is in an oxidizing atmosphere at this time, part of calcium carbonate (CaCO₃) is converted into calcium sulfate (CaSO₄).

When calcium sulfate (CaSO₄) is held at high temperatures while the air-fuel ratio of exhaust gas flowing into the particulate filter is kept at substantially the stoichiometric air-fuel ratio or an air-fuel ratio richer than the stoichiometric air-fuel ratio, that is, the particulate filter 24 is held in a reducing atmosphere, calcium sulfate (CaSO₄) is converted into calcium carbonate (CaCO₃) or calcium sulfide (CaS), calcium sulfide (CaS) is converted into calcium carbonate (CaCO₃) or calcium oxide (CaO), and calcium carbonate (CaCO₃) is converted into calcium oxide (CaO) as described above. The bonding energy of calcium carbonate (CaCO₃) or calcium sulfide (CaS) is higher than the bonding energy of calcium sulfate (CaSO₄), the bonding energy of calcium carbonate (CaCO₃) or calcium oxide (CaO) is higher than the bonding energy of calcium sulfide (CaS), and the bonding energy of calcium oxide (CaO) is higher than the bonding energy of calcium carbonate (CaCO₃). Therefore, when ash contains calcium carbonate (CaCO₃) and calcium sulfate (CaSO₄), calcium sulfate (CaSO₄) needs to be converted into calcium carbonate (CaCO₃) and calcium carbonate (CaCO₃) needs to be converted into calcium oxide (CaO) in order to cause ash to desorb from the inner peripheries 71is. In the embodiment shown in FIG. 20, when the ash desorption control should be executed, the temperature of the particulate filter is kept at the ash desorption temperature while the air-fuel ratio of exhaust gas flowing into the particulate filter is kept at substantially the stoichiometric air-fuel ratio or an air-fuel ratio richer than the stoichiometric air-fuel ratio. As a result, when ash contains calcium sulfate (CaSO₄) as well, the ash is reliably desorbed from the inner peripheries 71is.

That is, as shown in FIG. 21, as the estimated amount QPM of particulate matter collected exceeds the first PM set value QPM1 at time tg1, the PM removal control is started. As a result, the filter temperature TF is increased to the PM removal temperature TFPM, and is kept at the PM removal temperature TFPM. In this case, the air-fuel ratio ATE of exhaust gas flowing into the particulate filter 24 slightly decreases while being kept at an air-fuel ratio leaner than the stoichiometric air-fuel ratio AIS. Subsequently, as the estimated amount QPM of particulate matter collected becomes smaller than or equal to the second PM set value QPM2 at time tg2, the PM removal control is ended, and the ash desorption control is started. That is, the filter temperature TF is further increased to the ash desorption temperature TFA, and is kept at the ash desorption temperature TFA. In this case, the air-fuel ratio AFE of exhaust gas is changed to an air-fuel ratio richer than the stoichiometric air-fuel ratio AFS and is kept. Subsequently, as the estimated amount QA of ash deposited becomes smaller than or equal to the second ash set value QA2 at time tg3, the ash desorption control is ended. That is, the filter temperature TF is returned to the original temperature, and the air-fuel ratio AFE of exhaust gas is returned to the original air-fuel ratio.

Next, further another embodiment of the present disclosure will be described. In the embodiment described above, when the estimated amount QPM of particulate matter collected is smaller than or equal to the third PM set value QPM3 at the time when the estimated amount QA of ash deposited becomes larger than the first ash set value QA1, the ash desorption control is started. In other words, when the estimated amount QPM of particulate matter collected is larger than the third PM set value QPM3 at the time when the estimated amount QA of ash deposited becomes larger than the first ash set value QA1, the ash desorption control is not executed until the estimated amount QPM of particulate matter collected becomes smaller than or equal to the third PM set value QPM3 as a result of PM removal control thereafter. For this reason, when the PM removal control is not executed because of some reasons, there is a possibility that a state where the amount of ash deposited is large is kept for a long period of time.

In further another embodiment of the present disclosure, when the estimated amount QA of ash deposited becomes larger than a predetermined third ash set value QA3, even when the estimated amount QPM of particulate matter collected is larger than the third PM set value QPM3, the ash desorption control is started. As a result, the third ash set value QA3 is set so as to be larger than or equal to the above-described first ash set value QA1.

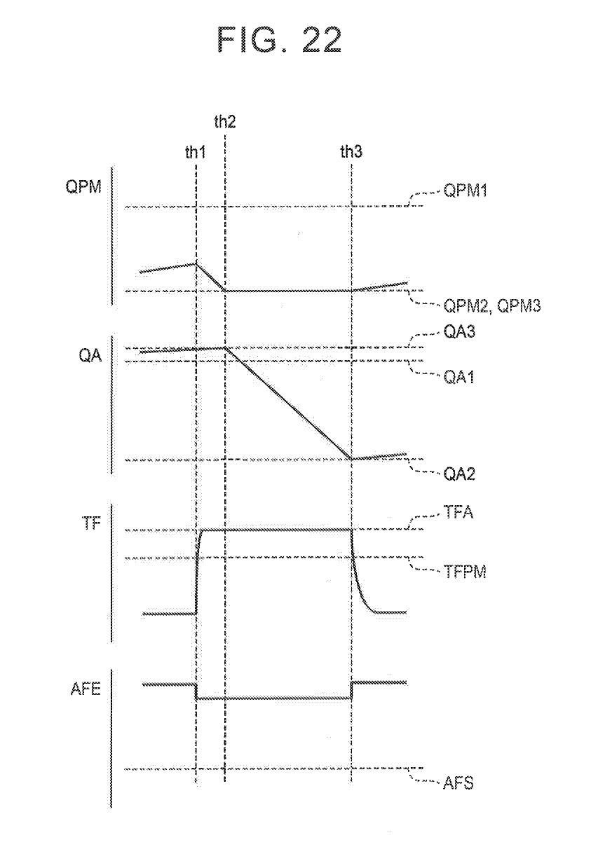

That is, as shown in FIG. 22, as the estimated amount QA of ash deposited exceeds the third ash set value QA3 at time th1, the ash desorption control is started. FIG. 22 shows the case where the third ash set value QA3 is set so as to be larger than the first ash set value QA1. As a result, the filter temperature TF is increased to the ash desorption temperature TFA, and is kept at the ash desorption temperature TFA. In the embodiment shown in FIG. 22, the air-fuel ratio AFE of exhaust gas flowing into the particulate filter 24 slightly decreases while being kept at an air-fuel ratio leaner than the stoichiometric air-fuel ratio AFS.

As the ash desorption control is started, the estimated amount QPM of particulate matter collected reduces. On the other hand, while the estimated amount QPM of particulate matter collected is larger than the third PM set value QPM3, conversion of ash into calcium oxide (CaO) does not proceed, so the estimated amount QA of ash deposited does not reduce. Subsequently, as the estimated amount QPM of particulate matter collected becomes smaller than or equal to the third PM set value QPM3 at time th2, the estimated amount QA of ash deposited begins to reduce.

Subsequently; as the estimated amount QA of ash deposited becomes smaller than or equal to the second ash set value QA2 at time th3, the ash desorption control is ended. That is, the filter temperature TF is returned to the original temperature, and the air-fuel ratio AFE of exhaust gas is returned to the original air-fuel ratio.

In this way, in the embodiment shown in FIG. 22, irrespective of the estimated amount QPM of particulate matter collected, the ash desorption control is forcibly executed. Therefore, an excessive increase in the amount of ash deposited is prevented.

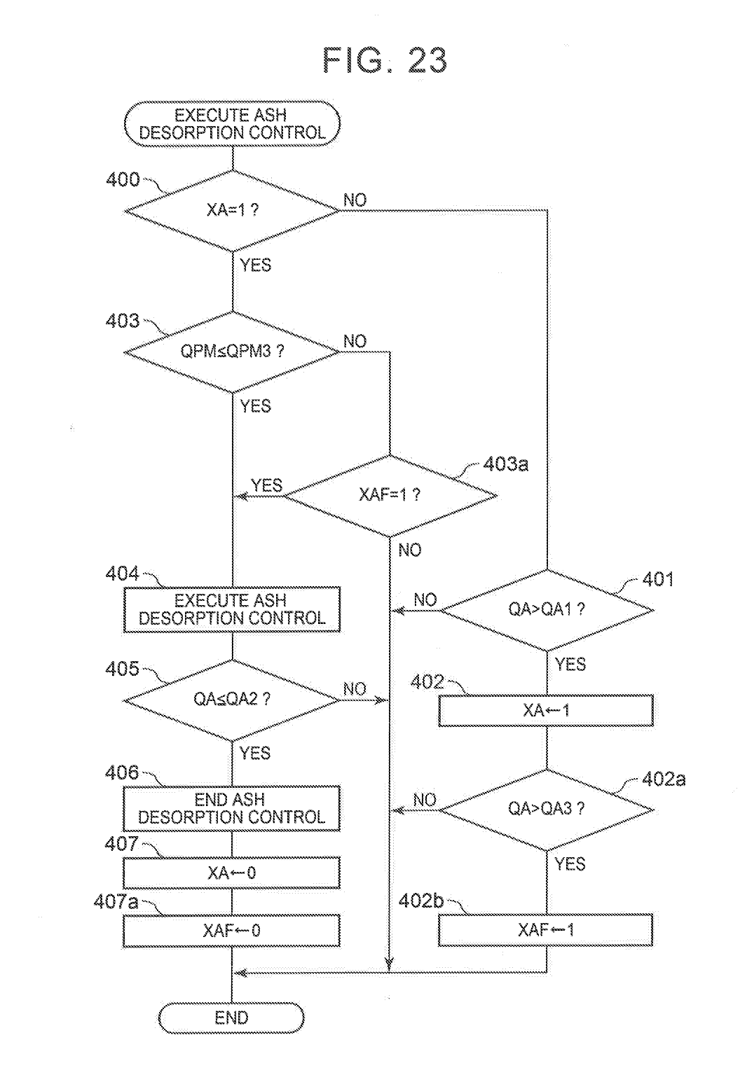

FIG. 23 shows the routine of executing the ash desorption control according to the embodiment shown in FIG. 22. This routine is repeatedly executed by an interrupt at predetermined set intervals. As shown in FIG. 23, in step 400, it is determined whether the flag XA is set. The flag XA is set (XA=1) when the ash desorption control should be executed; otherwise, the flag XA is reset (XA=0). When the flag XA, is reset, the process proceeds to step 401. In step 401, it is determined whether the estimated amount QA of ash deposited is larger than the first ash set value QA1. When QA≦QA1, the processing cycle is ended. When QA>QA1, the process proceeds to step 402, and the flag XA is set (XA=1). Subsequently, in step 402a, it is determined whether the estimated amount QA of ash deposited is larger than the third ash set value QA3. When QA≦QA3, the processing cycle is ended. When QA>QA3, the process proceeds to step 402b, and a flag XAF is set (XAF=1). The flag XAF is set (XAF=1) when the ash desorption control should be executed irrespective of the estimated amount QPM of particulate matter collected; otherwise, the flag XAF is reset (XAF=0).

When the flag XA is set, the process proceeds from step 400 to step 403. In step 403, it is determined whether the estimated amount QPM of particulate matter collected is smaller than or equal to the third PM set value QPM3. When QPM>QPM3, the process proceeds to step 403a . In step 403a , it is determined whether the flag XAF is set. When the flag XAF is reset, the processing cycle is ended. When the flag XAF is set, the process proceeds to step 404. When QPM≦QPM3, the process proceeds from step 403 to step 404. In step 404, the ash desorption control is executed. Subsequently, in step 405, it is determined whether the estimated amount QA of ash deposited is smaller than or equal to the second ash set value QA2. When QA>QA2, the processing cycle is ended. When QA≦QA2, the process proceeds to step 406, and the ash desorption control is ended. Subsequently, in step 407, the flag XA is reset (XA=0). Subsequently; in step 407a , the flag XAF is reset (XAF=0).

What is claimed is:

1. An exhaust emission control apparatus for an internal combustion engine, the exhaust emission control apparatus comprising:
a particulate filter arranged in an exhaust passage of the internal combustion engine, the particulate filter being configured to collect particulate matter in exhaust gas; and
an electronic control unit configured to
(i) execute particulate matter removal control by controlling the internal combustion engine such that a temperature of the particulate filter is increased to a predetermined particulate matter removal temperature in order to reduce an amount of particulate matter collected in the particulate filter, and
(ii) when the electronic control unit determines that the amount of particulate matter collected in the particulate filter is smaller than or equal to a predetermined set collection amount, execute ash desorption control by controlling the internal combustion engine such that the temperature of the particulate filter is increased to a predetermined ash desorption temperature and is kept at the ash desorption temperature or higher in order to reduce an amount of ash deposited in the particulate filter, the ash desorption temperature being a temperature suitable for converting the ash into calcium oxide.

2. The exhaust emission control apparatus according to claim 1, wherein the electronic control unit is configured to control the internal combustion engine such that a time during which the temperature of the particulate filter is kept at the ash desorption temperature or higher in the ash desorption control is longer than a time during which the temperature of the particulate filter is kept at the particulate matter removal temperature or higher in the particulate matter removal control.

3. The exhaust emission control apparatus according to claim 1, wherein the electronic control unit is configured to, when an increase caused by the particulate matter removal control, in a concentration of carbon oxide in exhaust gas flowing out from the particulate filter during the particulate matter removal control becomes smaller than or equal to a predetermined set value, determine that the amount of particulate matter collected in the particulate filter is smaller than or equal to the set collection amount.

4. The exhaust emission control apparatus according to claim 1, wherein the electronic control unit is configured to, when the particulate matter removal control is ended, determine that the amount of particulate matter collected in the particulate filter is smaller than or equal to the set collection amount.

5. The exhaust emission control apparatus according to claim 1, wherein the electronic control unit is configured to, when the electronic control unit determines that the amount of particulate matter collected in the particulate filter is smaller than or equal to the set collection amount and the amount of ash deposited in the particulate filter is larger than a first set deposition amount, execute the ash desorption control.

6. The exhaust emission control apparatus according to claim 5, wherein the electronic control unit is configured to, when the ash desorption control has been intermitted and subsequently when the electronic control unit determines that the amount of particulate matter collected in the particulate filter is smaller than or equal to the set collection amount, execute the ash desorption control even when the amount of ash deposited in the particulate filter is smaller than the first set deposition amount.

7. The exhaust emission control apparatus according to claim 1, wherein the electronic control unit is configured to, when the electronic control unit determines that the amount of ash deposited is smaller than or equal to a second set deposition amount during the ash desorption control, end the ash desorption control.

8. The exhaust emission control apparatus according to claim 7, wherein the electronic control unit is configured to determine that the amount of ash deposited is smaller than or equal to the second set deposition amount when a pressure loss in the particulate filter is smaller than or equal to a predetermined threshold, and the threshold is set so as to he smaller than a pressure loss in the particulate filter at a time when the particulate matter removal control is ended.

9. The exhaust emission control apparatus according to claim 1, wherein the particulate filter is arranged in the exhaust passage such that a concentration of sulfur oxide in exhaust gas that is emitted from the internal combustion engine and the concentration of sulfur oxide in exhaust gas flowing into the particulate filter are equal to each other, and the electronic control unit is configured to, when the ash desorption control is executed, control the internal combustion engine such that an air-fuel ratio of exhaust gas flowing into the particulate filter is kept at a stoichiometric air-fuel ratio or an air-fuel ratio richer than the stoichiometric air-fuel ratio and the temperature of the particulate filter is kept at the ash desorption temperature,

10. The exhaust emission control apparatus according to claim 1, wherein the ash desorption temperature is set so as to be higher than the particulate matter removal temperature.

11. The exhaust emission control apparatus according to claim 1, wherein the ash desorption temperature is set within a range of about 620° C. to about 800° C.
